(19) United States
(12) Patent Application Publication
(10) Pub. No.: US 2026/0364547 A1
(43) Pub. Date: Nov. 19, 2026

(54) TRAPPED VORTEX MIXER FOR MIXING FLUIDS

(71) Applicant: EKONA POWER INC., Burnaby (CA)

(72) Inventor: Donald W. KENDRICK, Bellevue, WA (US)

(21) Appl. No.: 19/136,487

(22) PCT Filed: Sep. 28, 2023
(86) PCT No.: PCT/CA2023/051283

§ 371 Date: Jun. 6, 2025

Related U.S. Application Data
(60) Provisional application No. 63/432,621, filed on Dec. 14, 2022.

(51) Int. Cl. B01F 25/314; B01F 25/431; B01F 35/90; B01F 101/00; C01B 3/24

(52) U.S. Cl. CPC B01F 25/3141; B01F 25/4317; B01F 25/431972; B01F 35/90; C01B 3/24; B01F 2035/98; B01F 2101/501

(57) ABSTRACT

A method of mixing a first fluid with a second fluid that is different from the first fluid uses a trapped vortex mixer. The trapped vortex mixer includes an axial flow channel and a vortex flow field offset from, and connected to, the axial flow channel. The vortex flow field is configured to cause fluid entering the vortex flow field to flow in a vortex inside the vortex flow field. The first fluid is flowed along the axial flow channel, and the second fluid is flowed into the vortex flow field. As a result of the second fluid entering the vortex flow field, the second fluid flows in a vortex inside the vortex flow field. In response to continued flow of the second fluid into the vortex flow field, the second fluid flowing in the vortex inside the vortex flow field is forced out of the vortex flow field and into the axial flow channel to mix with the first fluid.

### FIELD

The present disclosure relates to fluid mixing, and in particular to a trapped vortex mixer for mixing a first fluid with a second fluid.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by sufficiently raising the temperature of the feedstock gas to a point at which the chemical bonds of the elements of the feedstock gas break down.

Such pyrolysis may be achieved, for example, by bringing the feedstock gas into thermal contact with a hot fluid. For instance, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

In order for pyrolysis to be carried out in an efficient manner, it is important for the feedstock to be well mixed with the fluid. Proper mixing of the feedstock with the fluid will generally lead to improved heat transfer from the fluid to the feedstock, and may ensure high conversion efficiencies of the elemental constituents.

### SUMMARY

According to a first aspect of the disclosure, there is provided a method of mixing a first fluid with a second fluid that is different from the first fluid, wherein: the method uses a trapped vortex mixer comprising: an axial flow channel; and a vortex flow field offset from, and connected to, the axial flow channel, wherein the vortex flow field is configured to cause fluid entering the vortex flow field to flow in a vortex inside the vortex flow field; and the method comprises: flowing the first fluid along the axial flow channel; and flowing the second fluid into the vortex flow field, wherein: as a result of the second fluid entering the vortex flow field, the second fluid flows in a vortex inside the vortex flow field; and in response to continued flow of the second fluid into the vortex flow field, the second fluid flowing in the vortex inside the vortex flow field is forced out of the vortex flow field and into the axial flow channel to mix with the first fluid.

The trapped vortex mixer may further comprise, in the axial flow channel, a flow diverter with one or more vanes. The one more vanes may define one or more sheltered zones downstream of the one or more vanes to facilitate penetration of the second fluid into the flow of the first fluid.

The one or more vanes may further define an axial swirler. Flowing the first fluid along the axial flow channel may comprise flowing the first fluid over the axial swirler and thereby introducing bulk axial vorticity to the feedstock flowing downstream of the axial swirler.

The one or more vanes may comprise one or more surface features thereon for imparting streamwise vorticity to the first fluid flowing downstream of the one or more vanes.

The flow diverter may comprise a conical portion for accelerating the flow of the first fluid flowing over the conical portion so as to improve the mixing of the first fluid with the second fluid.

The vortex flow may be is connected to the axial flow channel such that second fluid flowing from the vortex flow field and into the axial flow channel enters the axial flow channel perpendicularly relative to the flow of the first fluid.

The vortex flow field may extend circumferentially around the axial flow channel. Flowing the second fluid into the vortex flow field may comprise flowing the second fluid into the vortex flow field at multiple entry points distributed within the vortex flow field.

The method may further comprise flowing a coolant adjacent to the vortex flow field.

The second fluid may comprise one or more combustion gases. The method may further comprise combusting the one or more combustion gases in the vortex flow field.

Combusting the one or more combustion gases may comprise combusting the one or more combustion gases in the presence of oxygen or air.

The first fluid may comprise a hydrocarbon feedstock.

The hydrocarbon feedstock may be methane.

The first fluid may be a feedstock, and the second fluid may be a hot fluid of a temperature sufficient such that, by mixing with the feedstock, the hot fluid chemically reacts with the feedstock to decompose the feedstock and thereby produce one or more products based on the chemical reaction between the hot fluid and the feedstock.

The first fluid may be a feedstock, and the second fluid may be a hot inert fluid of a temperature sufficient such that, by mixing with the feedstock, the hot inert fluid transfers thermal energy to the feedstock to cause decomposition of the feedstock.

According to a further aspect of the disclosure, there is provided a trapped vortex mixer for mixing a first fluid with a second fluid that is different from the first fluid, comprising: an axial flow channel; a vortex flow field offset from, and connected to, the axial flow channel, wherein the vortex flow field is configured to cause fluid entering the vortex flow field to flow in a vortex inside the vortex flow field; a first fluid inlet connected to the axial flow channel; one or more second fluid inlets connected to the vortex flow field; and one or more controllers configured to control valving so as to: flow the first fluid along the axial flow channel via the first fluid inlet; and flow the second fluid into the vortex flow field via the one or more fluid inlets, wherein: as a result of the second fluid entering the vortex flow field, the second fluid flows in a vortex inside the vortex flow field; and in response to continued flow of the second fluid into the vortex flow field, the second fluid flowing in the vortex inside the vortex flow field is forced out of the vortex flow field and into the axial flow channel to mix with the first fluid.

The vortex flow field may extend circumferentially around the axial flow channel. The one or more fluid inlets may comprise multiple fluid inlets distributed within the vortex flow field. The one or more controllers may be further configured to control the valving so as to flow the second fluid into the vortex flow field via the multiple fluid inlets.

The trapped vortex mixer may further comprise one or more coolant flow channels adjacent to the vortex flow field. The one or more controllers may be further configured to control the valving so as to flow a coolant along the one or more coolant flow channels.

The second fluid may comprise one or more combustion gases. The trapped vortex mixer may further comprise one or more igniters in the vortex flow field. The one or more controllers may be further configured to activate the one or more igniters so as to combust the one or more combustion gases in the vortex flow field.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 shows a side-on, cross-sectional view of a trapped vortex mixer according to an embodiment of the disclosure;

FIG. 2 shows a perspective, cross-sectional view of the trapped vortex mixer of FIG. 1;

FIGS. 3A and 3B show respective perspective and side-on, cross-sectional views a mixing assembly of the trapped vortex mixer of FIG. 1;

FIGS. 4A and 4B show perspective views the mixing assembly of FIGS. 3A and 3B;

FIG. 5 shows a perspective view of the trapped vortex mixer of FIG. 1;

FIGS. 6A-6C show different flow diverters according to embodiments of the disclosure;

FIG. 7A shows a side-on, cross-sectional view of a flow diverter with notched vanes for producing streamwise vorticity, according to an embodiment of the disclosure;

FIG. 7B shows a side-on, cross-sectional view of a flow diverter with an axial swirler for producing bulk axial swirl, according to an embodiment of the disclosure; and

FIGS. 8A-8D show respective perspective and end-on views of a flow diverter with notched vanes for producing streamwise vorticity, as well as cross-sections of the vanes, according to an embodiment of the disclosure.

### DETAILED DESCRIPTION

The present disclosure relates to a trapped vortex mixer for mixing a first fluid with a second fluid, and to methods of using the trapped vortex mixer. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is described a trapped vortex mixer having an axial flow channel and a vortex flow field offset from, and connected to, the axial flow channel. According to some embodiments, the vortex flow field is radially offset from the axial flow channel and, for example, may extend partially or fully in a circumferential direction around the axial flow channel. The vortex flow field is configured to cause fluid entering the vortex flow field to flow in a vortex inside the vortex flow field. For example, the vortex flow field should have an appropriate aspect ratio to naturally trap the vortical flow formed by the shear layer off upstream edges/corners of the vortex flow field. In addition, further flow of the fluid into the vortex flow field may ensure that the vortical flow is maintained within the vortex flow field.

A feedstock, such as a hydrocarbon or hydrogen, is caused to flow into and along the axial flow channel via one or more feedstock inlets. In addition, a fluid, such as a combustible mixture of a combustion gas (e.g. methane) and an oxidant (e.g. pure oxygen), is caused to flow into the vortex flow field via one or more fluid inlets. As a result of the fluid entering the vortex flow field, the fluid flows in a vortex inside the vortex flow field, as described above. In response to continued flow of the fluid into the vortex flow field, the fluid flowing in the vortex inside the vortex flow field is forced out of the vortex flow field and into the axial flow channel to rapidly mix with the feedstock.

According to some embodiments, assuming the fluid flowing inside the vortex flow field is combustible, the fluid flowing inside the vortex flow field is caused to combust, for example by activating one or more igniters inside the vortex flow field. Combustion of the fluid produces one or more hot combustion product gases (or simply “combustion products”). The generation of the combustion products may assist in driving the combustion products towards the axial flow channel. The combustion products may then flow into the axial flow channel and mix with the feedstock flowing along the axial flow channel. Mixing of the feedstock with the combustion products may cause thermal energy to be transferred from the combustion products to the feedstock, thereby decomposing the feedstock into its constituent components. In the event that the combustion products are not inert and are reactive with the feedstock, mixing of the feedstock with the combustion products may cause the combustion products to chemically react with the feedstock, thereby decomposing the feedstock and producing one or more products based on the chemical reaction between the combustion products and the feedstock.

The mixer is referred to generally as a “trapped vortex” mixer since fluid flowing into the vortex flow field is forced to flow in a vortex before eventually flowing to the axial flow channel.

According to some embodiments, the trapped vortex mixer may additionally include a flow diverter in the axial flow channel for inducing one or more flow characteristics in the stream of feedstock flowing along the axial flow channel. The flow diverter may take any of various suitable forms, as will be described in further detail below.

For example, according to some embodiments, the flow diverter may include an axial swirler (for example, formed of multiple, curved vanes) for inducing a bulk axial swirl/vorticity in the stream of feedstock flowing downstream of the axial swirler. By inducing a bulk axial swirl in the feedstock flowing downstream of the axial swirler, improved mixing of the feedstock with the fluid may be achieved.

According to some embodiments, the flow diverter may include one or more vanes (that may be straight or curved) with protuberances, notches, and/or recesses (or simply “surface features”) formed thereon. Such surface features may induce streamwise vorticity in the stream of feedstock flowing downstream of the surface features. When compared to bulk axial swirl, streamwise vorticity may refer to secondary streams of vortical flow within the majority of the flow of feedstock. Such secondary flow characteristics may further improve the mixing between the feedstock and the fluid entering the axial flow channel from the vortex flow field.

Generally, the presence of a vaned flow diverter may allow for one or more sheltered zones or recirculation zones to be formed downstream of the aft faces of the vanes. These sheltered zones enable the fluid entering the axial flow channel from the vortex flow field to penetrate more deeply into the feedstock stream.

One or more controllers (such as microcontrollers or any other suitable controllers) may be configured to initiate flow of the first and second fluids into the trapped vortex mixer by controlling suitable valving. The one or more controllers may additionally control the flow of a coolant for cooling one or more portions of the trapped vortex mixer, as well as controlling one or more igniters for triggering the combustion process described above.

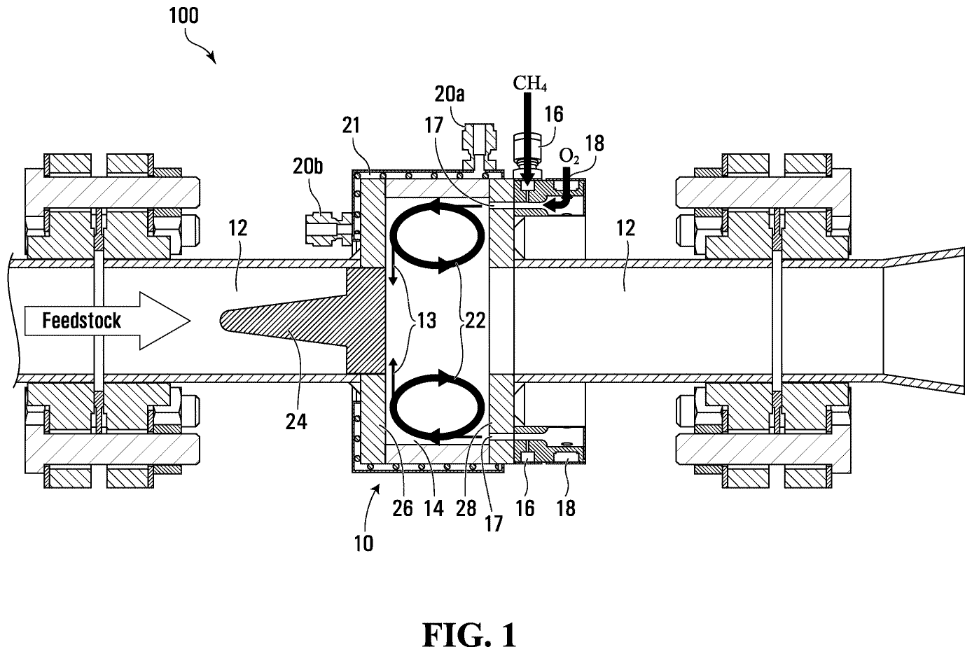

Turning now to FIGS. 1-3B, there is shown a side-on, cross-sectional view of a trapped vortex mixer 100 in accordance with an embodiment of the disclosure. Trapped vortex mixer 100 includes an axial flow channel 12 fluidly connected to a mixing assembly 10. In particular, axial flow channel 12 is connected to an entry of mixing assembly 10, defined by a front plate 26 of mixing assembly 10, and axial flow channel 12 is further connected to an exit of mixing assembly 10, defined by a rear plate 28 of mixing assembly 10.

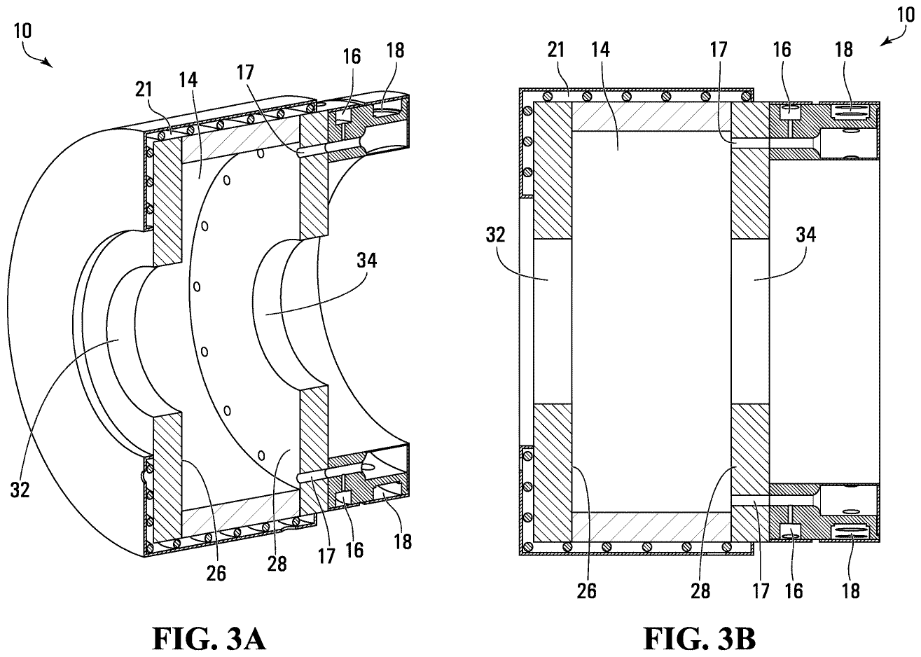

Mixing assembly 10 includes front plate 26 at a front thereof, and rear plate 28 at a rear thereof. Each plate includes a central opening (shown in more detail in FIG. 3A) formed therein. In particular, front plate 26 includes a front opening 32 for receiving feedstock flowing along axial flow channel 12, and rear plate 28 includes a rear opening 32 for allowing a mixture of feedstock and another fluid (as described in further detail below) to exit mixing assembly 10 and continue flowing along axial flow channel 12.

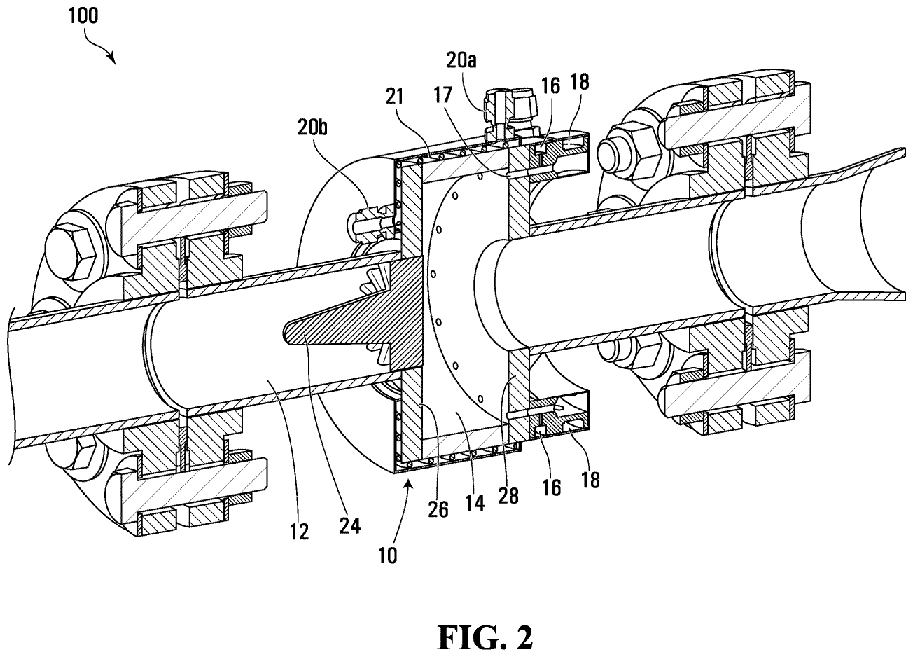

Mixing portion 10 further includes a number of combustion gas inlets 16 (two of which are shown in FIG. 1) and corresponding oxidant inlets 18. Combustion gas inlets 16 and oxidant inlets 18 are fluidly connected to fluid inlets 17 (shown in more detail in FIG. 2) that extend through rear plate 28. Fluid inlets 17 are connected to a circumferential vortex flow field 14 defined within mixing portion 10. Vortex flow field 14 is radially offset from, and surrounds, axial flow channel 12.

A feedstock (such as a hydrocarbon gas, or pure hydrogen) may be caused to flow under pressure (using, for example, one or more pumps or compressors) along axial flow channel 12. The feedstock therefore enters mixing assembly 10 via front opening 32 formed within front plate 26, and subsequently exits mixing assembly 10 via rear opening 34 formed within rear plate 28.

A conical flow diverter 24 is provided within axial flow channel 12 at a location upstream of mixing assembly 10. As described in further detail below, flow diverter 24 is configured to impart one or more flow characteristics to the stream of feedstock flowing over flow diverter 24. As can be seen in FIGS. 1 and 2, a base of flow diverter 24 is mounted within front opening 32, and feedstock is allowed to enter mixing assembly 10 by flowing past a number of vanes comprised on flow diverter 24, as described in further detail below.

A combustion gas (such as methane) may be caused to flow under pressure (using, for example, one or more pumps or compressors) into vortex flow field 14, by entering fluid passageways 17 via combustion gas inlets 16 and subsequently flowing into vortex flow field 14. In addition, an oxidant (such as pure oxygen) and/or fuel may be caused to flow under pressure (using, for example, one or more pumps or compressors) into vortex flow field 14, by entering fluid passageways 17 via oxidant inlets 18 and subsequently flowing into vortex flow field 14. The combustion gas and the oxidant may therefore mix within fluid passageways 17 and enter vortex flow field 14 in a pre-mixed state.

The combustible gas mixture entering vortex flow field 14 is then caused to flow in a vortex. As can be seen in FIG. 1, the combustible gas mixture flows in a vortex 22 whose axis is generally tangential to the circumferential direction of vortex flow field 14 around axial flow channel 12. As the combustible gas mixture flows within vortex flow field 14, one or more igniters inside vortex flow field 14 are activated to cause combustible gas mixture to combust and thereby generate hot combust product gases (“combustion products”). As described in further detail below, the presence of sheltered zones formed by flow diverter 24 (and in particular the vanes of flow diverter 24, as described in further detail below) then assist in allowing the combustion products to penetrate into the flow of feedstock along axial flow channel 12. In particular, the vortical flow of combustion products within vortex flow field 14 transitions from a circular flow within vortex flow field 14 to a radial flow 13 towards axial flow channel 12.

When entering axial flow channel 12, the hot combustion products generally enter the axial flow of feedstock orthogonally to the axial flow to ensure penetration and thorough mixing of the combustion products with the feedstock stream. This mixing of the combustion products with the feedstock stream will initiate decomposition of the feedstock. In particular, because of the flow of the combustion products into axial flow channel 12, and in particular, as a result of the mixing of the combustion products with the feedstock, thermal energy is transferred from the combustion products to the feedstock. Past a certain point, the increase in the temperature of the feedstock gas is sufficient to drive decomposition or pyrolysis of the feedstock. In the case of methane, the decomposition takes the following form:
CH₄+energy→C+2H₂

As can also be seen in FIGS. 1 and 2, a cooling jacket 21 (comprising, for example, one or more coolant flow channels) is provided around mixing assembly 10. A coolant inlet 20a and a coolant outlet 20b enable the flow of a coolant into and out of cooling jacket 21, for controlling the temperature of the walls of mixing assembly 10.

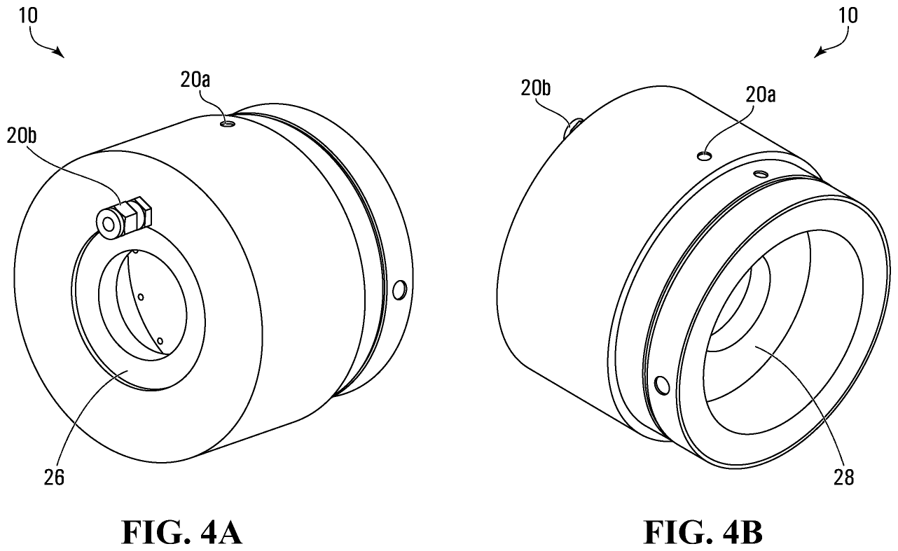

FIGS. 4A and 4B show perspective views mixing assembly 10, including coolant inlet 20a and coolant outlet 20b, and a view of rear plate 28 in FIG. 3B.

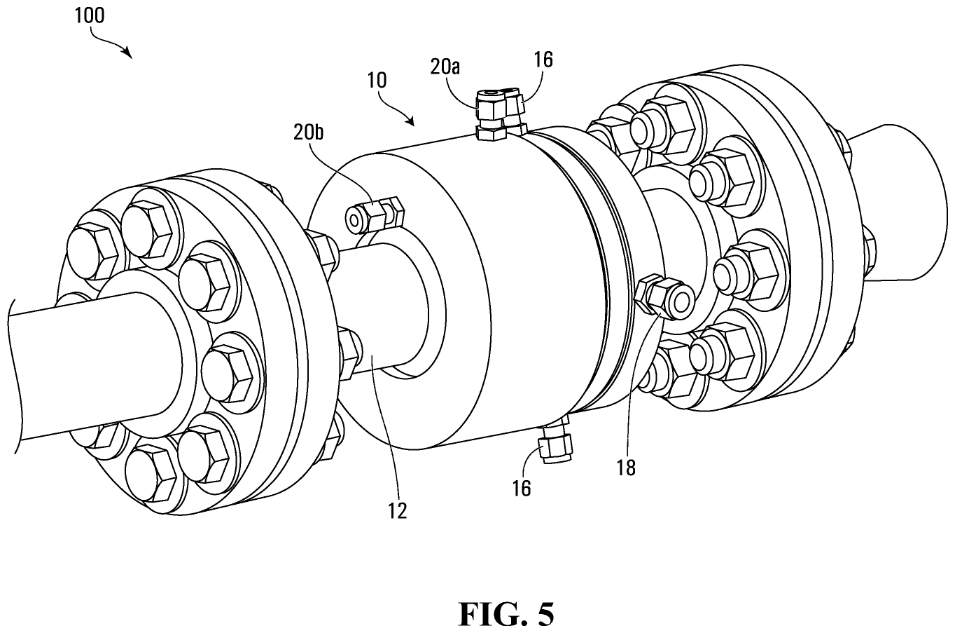

FIG. 5 shows a perspective view of trapped vortex mixer 100, including a view of an additional combustion gas inlet 16 and an additional oxidant inlet 18.

As now described in further detail below, mixing of the combustion products with the feedstock is further enhanced through the use of flow diverter 24.

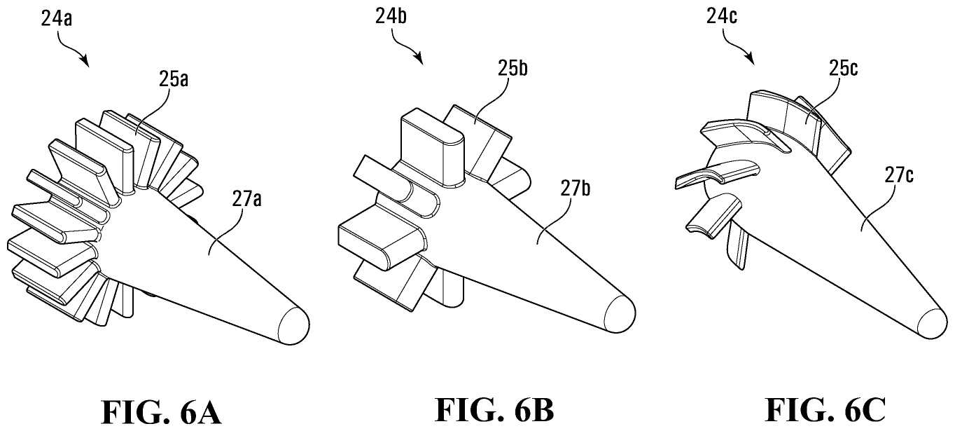

Turning to FIGS. 6A-6C, there are shown different embodiments of flow diverters 24 that may be provided within axial flow channel 12. According to a first embodiment, flow diverter 24a includes a conical portion 27a extending away from a base portion that includes a number of straight vanes 25a. Flow diverter 24b is similar to flow diverter 24a except that the base portion includes fewer straight vanes 25b. Vanes 25a, 25b are configured to define sheltered or recirculation zones downstream of respective flow diverters 24a, 24b. In these sheltered zones, the velocity of the feedstock is reduced relative to the velocity of the feedstock between vanes 25a, 25b. As a result, the momentum of the feedstock in the axial direction is reduced in the sheltered zones. This allows the combustion products radially flowing from vortex flow field 14 to axial flow channel 12, and which have a relatively higher momentum, to penetrate deeply into the axial flow of feedstock, instead of being confined to the shear interface between the feedstock stream and the radially-flowing stream of combustion products.

Generally, the conical portion of flow diverter 24 accelerates the flow of the feedstock flowing over the conical portion so as to improve the mixing of the feedstock with the combustion products.

FIG. 6C shows a further alternative flow diverter 24c including a conical portion 27c extending away from a base portion that includes a number of curved vanes 25c. Much like vanes 25a and 25b, vanes 25c are also configured to define sheltered or recirculation zones downstream of flow diverter 24c. In addition, the curved nature of vanes 25c allows vanes 25c to act as an axial swirler for imparting bulk axial vorticity/swirl to the feedstock flowing over vanes 25c. By introducing bulk axial vorticity/swirl to the feedstock stream downstream of flow diverter 25c, improved mixing between the combustion products and the feedstock may be achieved. Such bulk axial swirl may additionally assist in scrubbing the interior walls of axial flow channel 12 and thereby mitigate soot/carbon buildup on these walls.

According to further embodiments, and as described above, the vanes provided on flow diverter 24 may include one or more aerodynamic features such as protuberances, notches, and/or recesses (“surface features”) for imparting additional flow characteristics to the stream of feedstock. In particular, such surface features may impart streamwise vorticity to the feedstock stream, to enable secondary mixing between the combustion products and the feedstock. Generally, streamwise vorticity may be lead to less pronounced mixing than bulk axial swirl (which generally involves the majority of the feedstock stream), but nevertheless may further augment the mixing between the feedstock and the combustion products, especially if combined with bulk axial swirl induced by an axial swirler.

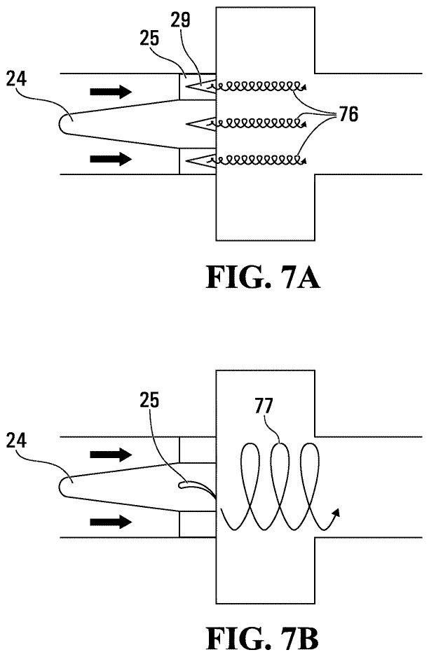

FIGS. 7A and 7B show examples of bulk axial swirl and streamwise vorticity introduced to the feedstock stream. In particular, as can be seen in FIG. 7A, flow diverter 24 includes vanes 25 with surface features 29 formed thereon. Surface features 29 produce streamwise vortices 76 in the feedstock stream, downstream of flow diverter 24. In FIG. 7B, flow diverter 24 includes curved vanes 25 forming an axial swirler which produces a bulk axial swirl or vortex 77 in the feedstock stream, downstream of flow diverter 24.

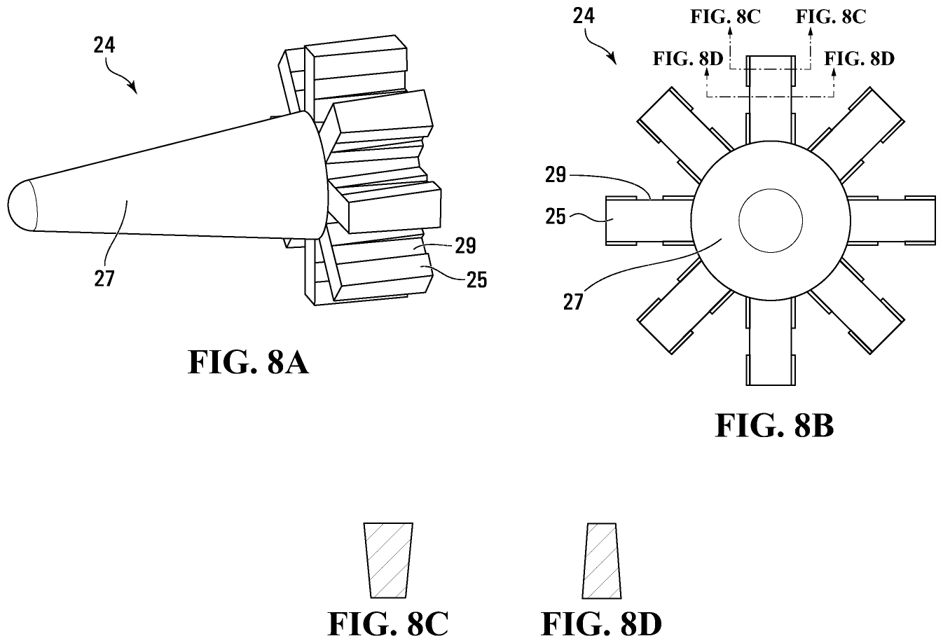

FIGS. 8A-8D show an example of a flow diverter 24 including a conical portion 27 with multiple vanes 25 extending from a bottom of conical portion 27. Vanes 25 include recesses or notches 29 formed therein, for introducing streamwise vorticity in the feedstock stream, as descried above.

It shall be recognized that the disclosure extends to trapped vortex mixers in which the above-described flow diverter may be provided without any conical portion. For example, flow diverters 24a, 24b, 24c shown in FIGS. 6A-6C may be provided within axial flow channel 12 but without any conical portions 27a, 27b, 27c.

Furthermore, the drawings have illustrated an example trapped vortex mixer that includes two combustion gas inlets 16 and two oxidant inlets 18. According to other embodiments, any number of combustion gas inlets and oxidant inlets may be provided. For example, any suitable number of combustion gas inlets and oxidant inlets may extend around the circumference of mixing assembly 10, to provide multiple entry points distributed along the circumference of vortex flow field 14.

Further still, while the flow diverters have been described herein as including generally conical portions, it shall be recognized that the disclosure extends to other types and shapes of flow diverters, such as flow diverters with non-conical shapes. In this context, conical should be construed broadly and is held to encompass cone-like shapes, such as pyramid-shaped flow diverters.

The trapped vortex mixer described herein may be used in a steady-state, stead-flow process whereby feedstock is constantly flowed along axial flow channel 12 and hot combustion products are constantly generated within vortex flow field 14 and then forced into axial flow channel 12 to mix with, and decompose, the feedstock.

Other means of triggering combustion of the combustible gas mixture within vortex flow field 14 may be used. For example, instead of using igniters, the feedstock may be delivered to axial flow channel 12 at a temperature (known as an auto-ignition temperature) that is already sufficiently high to trigger combustion of the combustible gas mixture in response to the combustible gas mixture flowing from vortex flow field 14, into axial flow channel 12 and contacting the feedstock gas. Therefore, according to such embodiments, there is no need to ignite the combustible gas mixture prior to injecting the combustible gas mixture into axial flow channel 12, and instead the combustible gas mixture may spontaneously combust as a result of flowing into axial flow channel 12 and contacting the feedstock.

While only a certain number of vane and surface feature configurations have been illustrated and described, the disclosure extends to any number of suitable vane and surface feature configurations, such as curved vanes with surface features for imparting bulk axial swirl in addition to streamwise vorticity.

While the above embodiments have generally been described in the context of decomposing hydrocarbons (including, for example, natural gas, methane, ethylene, and propylene), the concepts described herein may be applied to other feedstocks, such as ammonia and methanol.

Furthermore, while the disclosure has generally been presented in the context of mixing a hot fluid with a feedstock in order to chemically drive decomposition of the feedstock, more generally the disclosure extends to a trapped vortex mixer that may be used to better mix a first fluid with a second fluid. For example, according to some embodiments, combustion of the combustible gas mixture may be configured to take place once the combustible gas mixture and the feedstock have already been mixed within mixing assembly 10, and the mixed stream has exited mixing assembly 10.

The terms “a” or “an” when used in conjunction with the terms “comprising” or “including” in the claims and/or the specification can mean “one” but it is also consistent with the meaning of “one or more”, “at least one”, and “one or more than one” unless the content clearly dictates otherwise. Similarly, the word “another” may mean at least a second or more, unless the content clearly dictates otherwise.

The terms “coupled”, “coupled”, or “connected” as used herein, may have a number of different meanings depending on the context in which the terms are used. For example, the terms coupled, or connected may have a mechanical or electrical meaning. For example, as used herein, the terms coupled, or connected may indicate that two elements or devices are connected to each other directly or via one or more intermediate elements or devices via electrical, or mechanical elements, depending on the particular context. The term “and/or” as used herein when used in association with a list of items refers to any one or more of the items comprising the list.

As used herein, reference to “about” or “approximately” a number or “substantially” is equal to a number means within +/−10% of the number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of decomposing a feedstock, wherein:
the method uses a trapped vortex mixer comprising:
an axial flow channel; and
a vortex flow field offset from, and connected to, the axial flow channel, wherein the vortex flow field is configured to cause fluid entering the vortex flow field to flow in a vortex inside the vortex flow field; and
the method comprises:
flowing a first fluid along the axial flow channel; and
flowing a second fluid into the vortex flow field, wherein:
as a result of the second fluid entering the vortex flow field, the second fluid flows in a vortex inside the vortex flow field; and
in response to continued flow of the second fluid into the vortex flow field, the second fluid flowing in the vortex inside the vortex flow field is forced out of the vortex flow field and into the axial flow channel to mix with the first fluid,
wherein the first fluid is a feedstock, and wherein the second fluid forced out of the vortex flow field and into the axial flow channel is a hot fluid of a temperature sufficient such that, by mixing with the feedstock, the hot fluid transfers thermal energy to the feedstock to cause decomposition of at least some of the feedstock by pyrolysis and thereby produce one or more products.

2. The method of claim 1, wherein:
the trapped vortex mixer further comprises, in the axial flow channel, a flow diverter with one or more vanes, wherein the one more vanes define one or more sheltered zones downstream of the one or more vanes to facilitate penetration of the second fluid into the flow of the first fluid.

3. The method of claim 2, wherein:
the one or more vanes further define an axial swirler; and
flowing the first fluid along the axial flow channel comprises flowing the first fluid over the axial swirler and thereby introducing bulk axial vorticity to the feedstock flowing downstream of the axial swirler.

4. The method of claim 2, wherein the one or more vanes comprise one or more surface features thereon for imparting streamwise vorticity to the first fluid flowing downstream of the one or more vanes.

5. The method of claim 2, wherein the flow diverter comprises a conical portion for accelerating the flow of the first fluid flowing over the conical portion so as to improve the mixing of the first fluid with the second fluid.

6. The method of claim 1, wherein the vortex flow field is connected to the axial flow channel such that the second fluid flowing from the vortex flow field and into the axial flow channel enters the axial flow channel perpendicularly relative to the flow of the first fluid.

7. The method of claim 1, wherein:
the vortex flow field extends circumferentially around the axial flow channel; and
flowing the second fluid into the vortex flow field comprises flowing the second fluid into the vortex flow field at multiple entry points distributed within the vortex flow field.

8. The method of claim 1, further comprising:
flowing a coolant adjacent to the vortex flow field.

9. The method of claim 1, wherein:
the second fluid flowing into the vortex flow field comprises one or more combustion gases;
the method further comprises combusting the one or more combustion gases in the vortex flow field; and
the hot fluid comprises one or more combustion products formed as a result of the combustion.

10. The method of claim 9, wherein combusting the one or more combustion gases comprises combusting the one or more combustion gases in the presence of oxygen or air.

11. The method of claim 1, wherein the first fluid comprises a hydrocarbon feedstock.

12. The method of claim 11, wherein the hydrocarbon feedstock is methane.

13. (canceled)

14. The method of claim 1, wherein the second fluid is an inert fluid.

15. A trapped vortex mixer for decomposing a feedstock, comprising:
an axial flow channel;
a vortex flow field offset from, and connected to, the axial flow channel, wherein the vortex flow field is configured to cause fluid entering the vortex flow field to flow in a vortex inside the vortex flow field;
a first fluid inlet connected to the axial flow channel;
one or more second fluid inlets connected to the vortex flow field; and
one or more controllers configured to control valving so as to:
flow a first fluid without any oxidant along the axial flow channel via the first fluid inlet; and
flow a second fluid into the vortex flow field via the one or more second fluid inlets, wherein:
as a result of the second fluid entering the vortex flow field, the second fluid flows in a vortex inside the vortex flow field; and
in response to continued flow of the second fluid into the vortex flow field, the second fluid flowing in the vortex inside the vortex flow field is forced out of the vortex flow field and into the axial flow channel to mix with the first fluid,
wherein the first fluid is a feedstock, and wherein the second fluid forced out of the vortex flow field and into the axial flow channel is a hot fluid of a temperature sufficient such that, by mixing with the feedstock, the hot fluid transfers thermal energy to the feedstock to cause decomposition of at least some of the feedstock by pyrolysis and thereby produce one or more products.

16. The trapped vortex mixer of claim 15, further comprising, in the axial flow channel, a flow diverter with one or more vanes, wherein the one more vanes define one or more sheltered zones downstream of the one or more vanes to facilitate penetration of the second fluid into the flow of the first fluid.

17. The trapped vortex mixer of claim 16, wherein the one or more vanes further define an axial swirler for introducing bulk axial vorticity to the first fluid flowing downstream of the axial swirler.

18. The trapped vortex mixer of claim 16, wherein the one or more vanes comprise one or more surface features thereon for imparting streamwise vorticity to the first fluid flowing downstream of the one or more vanes.

19. The trapped vortex mixer of claim 16, wherein the flow diverter further comprises a conical portion for accelerating the flow of the first fluid flowing over the conical portion so as to improve the mixing of the first fluid with the second fluid.

20. (canceled)

21. The trapped vortex mixer of claim 15, wherein:
the trapped vortex mixer further comprises one or more coolant flow channels adjacent to the vortex flow field; and
the one or more controllers are further configured to control the valving so as to flow a coolant along the one or more coolant flow channels.

22.-25. (canceled)

26. The method of claim 1, wherein, by mixing with the feedstock, the hot fluid chemically reacts with the feedstock, and the one or more products are based on the chemical reaction between the hot fluid and the feedstock.
